(19) United States
(12) Patent Application Publication
(10) Pub. No.: US 2023/0020375 A1
(43) Pub. Date: Jan. 19, 2023

(54) A METHOD OF PRODUCING A CERAMIC SUPPORT AND A CERAMIC SUPPORT

(71) Applicant: LIQTECH INTERNATIONAL A/S, Ballerup (DK)

(72) Inventor: Jan Hoffmann JØRGENSEN, Ballerup (DK)

(73) Assignee: LIQTECH INTERNATIONAL A/S, Ballerup (DK)

(21) Appl. No.: 17/784,853

(22) PCT Filed: Dec. 11, 2020
(86) PCT No.: PCT/EP2020/085768

§ 371 Date: Jun. 13, 2022

(30) Foreign Application Priority Data
Dec. 13, 2019 (DK) PA 2019 01472

(51) Int. Cl. B01J 35/04; B01J 21/08; B01J 21/04; B01J 27/224; B01J 35/00; B01J 35/10; B01J 37/02; B01J 37/08; B01J 37/00; B01J 37/04

(52) U.S. Cl. CPC B01J 35/04; B01J 21/08; B01J 21/04; B01J 27/224; B01J 35/0013; B01J 35/1061; B01J 35/1066; B01J 35/1071; B01J 35/1076; B01J 35/1095; B01J 37/0228; B01J 37/0244; B01J 37/0236; B01J 37/08; B01J 37/0018; B01J 37/04

(57) ABSTRACT

Herein is disclosed a method of producing a ceramic support suitable for a catalyst, the method comprising providing a porous ceramic structure, comprising a body portion with a monomodal macropore structure, wherein the macropores comprises a first mean pore size; washcoating the porous ceramic structure using a suspension comprising oxide and/or hydroxide nanoparticles and drying and calcinating the washcoated porous ceramic structure at a temperature below the melting point of the nanoparticles. In addition, the ceramic support and its structure is disclosed.

### TECHNICAL FIELD

The present invention relates to a ceramic support suitable for supporting a catalyst, such as a Supported Ionic Liquid Phase (SILP) and Supported Liquid Phase (SLP) catalysts.

### BACKGROUND

Catalysts are widely used in various chemical processes for intensifying a desired reaction process e.g. for increasing reaction rate, for prioritizing a desired reaction and/or for enabling a desired reaction at a reduced temperature. Catalytic beds usually comprise a packed or fixed bed of pellets. Such pellets are usually solid supports carrying a catalyst. Monolithic catalysts are heterogeneous catalyst comprising an open pored porous catalytic support with a catalyst spread onto its surface.

A monolithic support prevents or reduces agglomeration and/or sintering of small catalyst particles, thereby exposing more catalyst surface area. Supports are usually porous materials with a high surface area, most commonly alumina, zeolites or various kinds of activated carbon.

U.S. 2010/0191006 discloses porous ceramic support for a silver based ethylene oxide catalysts. It is mentioned that the support may have a multimodal pore size distribution.

U.S. Pat. No. 8,242,045 discloses a combustion catalyst system, wherein an underlying metallic support structure is coated with a layer of a ceramic catalyst support within which is distributed one or more active catalyst species such as a noble metal or other catalytic material known in the art. The catalyst species may be uniformly distributed throughout the catalyst support or there may be a concentration gradient across a depth of the catalyst support layer.

U.S. Pat. No. 9,149,795 discloses a ceramic catalyst carrier for the decomposition of high-energy-density ionic salt monopropellants. The carrier comprising of partially or fully stabilized zirconia (ZrO₂) or hafnia (HfO₂) contains one or more metal oxide stabilizers. The ceramic catalyst carrier is produced by traditional ceramic processing techniques such as reactive sintering, sol-gel, or co-precipitation.

For high efficiency of a catalyst, it is generally desired to have a large specific surface area as well as a relatively low pressure drop over the catalyst. However, increasing the specific surface area generally results in an increase in pressure drop over the catalyst and hence in a reduced flow rate through the monolithic catalyst.

### DISCLOSURE OF INVENTION

An objective of the invention is to provide a method of producing a ceramic support for a catalyst, which has a high specific surface area and at the same time allow a high flow rate through the monolithic catalyst.

In an embodiment, it is an objective of the invention to provide a monolithic ceramic support, which has a structure that enables an effective monolithic catalyst with a high specific surface and relatively low flow resistance.

In an embodiment, it is an objective of the invention to provide a method of producing a ceramic support for a catalyst, by use of which method a ceramic support with a desired pore structure may be obtained.

In an embodiment, it is an objective of the invention to provide a method of producing a ceramic catalyst, which has a high specific surface area.

In an embodiment, it is an objective of the invention to provide a ceramic support, such as a monolithic ceramic support, suitable for supporting a catalyst and which has a high specific surface area and at the same time allow a high flow rate through the support

In an embodiment, it is an objective of the invention to provide a monolithic catalyst, which has a high specific surface area and at the same time allow a high flow rate through the monolithic catalyst.

In an embodiment, it is an objective of the invention to provide a ceramic support, suitable for supporting a chemically selective membrane.

In an embodiment, it is an objective of the invention to provide a monolithic catalyst, with a desired structure enabling a high efficiency.

These and other objects have been solved by the invention as defined in the claims and as described herein.

The inventors of the present invention has found a method of controlling the porous structure of the ceramic support during production thereof such that it is now possible to obtain a ceramic support which is has a high specific surface area and at the same time allow a high flow rate and hence may be used for producing a very effective supported catalyst.

The method of producing the ceramic support suitable for a catalyst, comprises the steps
providing a porous ceramic structure, comprising a body portion with a monomodal macropore structure, wherein the macropores comprises a first mean pore size (MP50);
washcoating the porous ceramic structure using a suspension comprising oxide and/or hydroxide nanoparticles;
drying and calcinating the washcoated porous ceramic structure at a temperature below the melting point of the nanoparticles.

A core element of the method is to modify the macroporous structure of the body portion by impregnating the body portion with a suspension of oxide and/or hydroxide nanoparticles, preferably metal oxide and/or hydroxide nanoparticles. The parent metal of both oxides and hydroxides may advantageously be chosen from alkali metals, earth alkali metals, transition metals and semimetals. Upon drying and calcinating, the nanoparticles build a secondary porous structure within the monomodal macropore structure of the body portion resulting in a multi modal pore structure, having a trimodal, a quadrimodal or a pentamodal porous structure. This structure ensures a very high specific surface area and at the same time, the flow resistance is relatively low. Without being bound by the theory, it is believed that the relatively low flow resistance is caused by the macropore structure, which forms a network of passage through the body portion while the surfaces of the secondary pores formed within the macropores ensure the very high specific surface without resulting in any excessive increase in flow resistance.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

Reference made to “some embodiments” or “an embodiment” means that a particular feature, structure, or characteristic described in connection with such embodiment(s) is included in at least one embodiment of the subject matter disclosed. Thus, the appearance of the phrases “in some embodiments” or “in an embodiment” in various places throughout the specification is not necessarily referring to the same embodiment(s). Further, the skilled person will understand that particular features, structures, or characteristics may be combined in any suitable manner within the scope of the invention as defined by the claims.

The term “substantially” should herein be taken to mean that ordinary product variances and tolerances are comprised.

Throughout the description or claims, the singular encompasses the plural unless otherwise specified or required by the context.

The terms “particle” and “grain” are used interchangeable.

All features of the invention and embodiments of the invention as described herein, including ranges and preferred ranges, may be combined in various ways within the scope of the invention, unless there are specific reasons not to combine such features.

Advantageously, the first mean pore size has a narrow pore size distribution wherein at least 50% by volume of the macropores has a pore size diameter within±5% from the mean pore size, preferably at least about 75% by volume of the macropores has a pore size diameter within±5% from the mean pore size, preferably at least about 95% by volume of the macropores has a pore size diameter within±5% from the mean pore size. This narrow pore size distribution ensures a relatively low flow resistance within body portion. The first mean pore size of the macropores is advantageously between 2 and 100 μm, such as between 4 and 50 μm, such as between 6 and 25 μm.

The porous ceramic structure and the body portion may in principle comprise any ceramic components. Advantageously the body portion of the porous ceramic structure comprises one or more crystalline ceramic components selected from oxide or non-oxide ceramics or any combinations thereof, such as the ceramics mentioned below or any combinations comprising one or more thereof.

From oxidic ceramics, preferably but not limited to alumina, zirconia, titania or mullite.

From non-oxide ceramics, preferably but not limited to borides, nitrides or carbides, preferably silicon carbide.

In an embodiment, the body portion of the porous ceramic structure comprises one single ceramic component.

In an embodiment, the body portion of the porous ceramic structure comprises or consist of silicon carbide.

In an embodiment, the porous ceramic structure is of composite material, preferably comprising two or more different ceramic components.

The washcoating may be performed using any method for wetting and fully or partly impregnating the body portion of the porous ceramic structure with the suspension of oxide and/or hydroxide nanoparticles. The washcoating may for example be performed by dipping, spraying, immersing and/or any other methods that ensure a precipitation of the nanoparticles within the macropores of the body portion.

In an embodiment, the washcoating is performed by dipping and/or immersing a porous ceramic structure into the suspension of oxide and/or hydroxide nanoparticles.

After contacting the porous ceramic structure with the suspension of oxide and/or hydroxide nanoparticles, excess of suspension may advantageously be removed e.g. by allowing the body portion to drip of and/or blowing of the excess of suspension e.g. using air-knifing.

In an embodiment, one single washcoating is sufficient, such a single washcoating may in an embodiment be sufficient for reaching saturation. In another embodiment, the single washcoating does not result in saturation of the porous body. The washcoating may be repeated if desired. In an embodiment, saturation is not desired. In an embodiment, the washcoating is repeated until saturation is reached.

After washcoating the porous ceramic structure, the porous ceramic structure is dried e.g. by air drying or by arranging in a drying chamber.

After drying, the porous ceramic structure is subjected to a calcination process, comprising heating treating of the porous ceramic structure in a furnace or reactor at a temperature and for a time period sufficient for calcining the nanoparticles participated within the macropores.

Preferred calcination temperatures are within 400-1000° C., with an optimal temperature or temperature range depending on the oxide or hydroxide. In an embodiment, it is desired to perform the calcination at a temperature within 0.45-0.55 times the melting temperature given in Kelvin (or average melting temperature) of the nanoparticles, preferably at the Tammann temperature of the nanoparticles or less than the Tammann temperature.”

In an embodiment, the Tammann temperature of a component may be determined as 0.5 Tm, where Tm is its melting point in Kelvin of the nanoparticles.

The oxide and/or hydroxide nanoparticles are advantageously metal oxide and/or metal hydroxide nanoparticles.

Examples of suitable metal oxides or metal hydroxides includes, but is not limited to, scandium, yttrium, titanium, zirconium, aluminum, gallium, indium, silicon, germanium, antimony, lanthanum, cerium, samarium, hafnium oxide and/or hydroxide or any combinations comprising one or more thereof.

The nanoparticles have a D50 grain size of from about 0.1-200 nm, such as from about 1-150 nm.

The mean grain size (D50) is the grain size where about 50% by volume of the grains have a grain size smaller or equal to the mean grain size.

The selection of the grain size of the nanoparticles may influence the final pore distribution in the body portion.

In an embodiment, the nanoparticles are selected to have a relatively narrow grain size distribution.

Advantageously, the nanoparticles are selected to have grain size distribution wherein at least 50% by number of the nanoparticles have a particle size within±5% from the mean particle size, preferably at least about 75% by number of the nanoparticles have a particle size within±5% from the mean particle size, preferably at least about 95% by number of the nanoparticles have a particle size within±5% from the mean particle size.

In an embodiment, the nanoparticles have a grain size distribution comprising that at least 90% by weight of the grains is within 0.5 times to 2 times the D50 grain size.

In an alternative embodiment, the nanoparticles have a bimodal grain size distribution comprising a fraction of nanoparticles with a larger D50 grain size and a fraction of nanoparticles having another smaller D50 grain size distribution.

The suspension is advantageously a colloidal suspension, such as an aqueous or organic suspension. The suspension may advantageously comprise water, polyvinyl alcohol, acetic acid, ethanol, organic binder or any combinations comprising one or more of these.

The amount of nanoparticles may be selected in dependence of the desired pore size distribution. The suspension of nanoparticles may for example comprise of from about 1% by weight to about 70% by weight of the nanoparticles. In an embodiment, the suspension of nanoparticles comprises from about 25 to about 60% by weight of the nanoparticles.

In an embodiment, the porous ceramic structure comprises a skin layer. The skin layer is in particular desired where the monolith is prepared to support a chemically selective membrane of organic or inorganic nature.

The skin layer may advantageously be applied to the porous ceramic structure before performing a washcoat with oxide and/or hydroxide nanoparticles, where the oxide and/or hydroxide nanoparticles have a lower Tammann temperature than the Tammann temperature of the skin layer material.

The skin layer is a thin ceramic layer comprising a skin layer mean pore size. Preferably the skin layer mean pore size is up to about 25% of the first mean pore size, such as up to about 15% of the first mean pore size of the body portion.

The skin layer is advantageously applied onto the body portion. The thickness of the skin layer is advantageous very low, such as up to about 50 μm, such as from about 1 to about 25 μm.

The pore size of the skin layer is advantageously appropriately sized for the membrane application. The main purpose of the skin layer is to provide a surface for adhering a membrane layer, such as a chemically selective membrane.

In principle the skin layer pores may have any pore size distribution, provided that the larger pores are not too large. Hence, to control the pore size it may be beneficial to ensure that the pore size distribution is relatively narrow.

In an embodiment, the pores of the skin layer has a narrow pore size distribution wherein at least 50% by volume of the skin layer pores has a pore size diameter within±5% from the skin layer mean pore size, preferably at least about 75% by volume of the skin layer has a pore size diameter within±5% from the skin layer mean pore size, preferably at least about 95% by volume of the skin layer pores has a pore size diameter within±5% from the skin layer mean pore size.

The skin layer mean pore size is advantageously about 3 μm or less. Preferably, the skin layer mean pore size is between 1 nm and 1 μm, such as between 400 nm and 2 μm, such as between 600 nm and 3 μm.

The skin layer may comprise any ceramic compounds, such as the ceramic compounds mentioned above. The skin layer may in an embodiment, comprise at least one of the ceramic compounds comprised in the body portion. In an embodiment, the skin layer comprises at least one other ceramic component than the body portion.

The skin layer may form an outer surface layer of the porous ceramic structure and may at least partly covering the body portion. Advantageously the skin layer covers only a part of the outer surface area of the body portion. To ensure that fluid can pass into the porous structure of the body portion without having to pass through the skin layer. As described further herein the body portion preferably is shaped to have one or more channels, such as through going channels. Advantageously, the surfaces of such channels are not covered by the skin layer and not covered by the membrane.

The ceramic support comprising the skin layer may be suitable for supporting a chemically selective membrane, such as an organic or inorganic membrane e.g. a polymeric membrane. The selective membrane may be applied to the skin layer using any desired coating methods.

The porous ceramic structure and thereby the ceramic support may be a monolithic structure or it may be a pellet, suitable for a catalytic bed, such as a packed bed or a fixed bed.

Preferably, the ceramic support is a monolithic support.

As mentioned above, it is desired that porous ceramic structure is shaped to comprise at least one channel, such as at least one, preferably a plurality of channels of polygonal, circular or elliptical shape.

In an embodiment, the porous ceramic structure consists of the body portion with a monomodal macropore structure.

The porous ceramic structure consisting of the body portion, may be a silicon carbide membrane, commercially available from Liqtech International, Denmark.

In an embodiment, the method comprises producing the body portion of the porous ceramic structure, the method comprising
selecting a first ceramic powder with a first mean grain size,
selecting a second ceramic powder with a second mean grain size that is substantially smaller than the first mean grain size,

mixing of the first and second ceramic powders with one or more additive to form a paste,
shaping the paste to a green ceramic structure, and
sintering the green ceramic structure at a temperature sufficiently high to at least partly sintering the ceramic grains.

The body portion may be produced as described in U.S. Pat. No. 7,699,903.

The sintering of the green ceramic structure may advantageously be performed in inert environments. This is particularly desired where the ceramic powder comprises or is of non-oxide ceramic material, such as boride, nitride and/or carbide.

Advantageously the sintering is performed in a vacuum atmosphere or in an inert gas atmosphere, such as in argon and/or nitrogen.

Due to the additive in the paste forming the green ceramic structure, the sintering process may result in generation of free carbon in the sintered porous ceramic structure.

In an embodiment, the method comprises purifying the sintered porous ceramic structure by subjecting the porous ceramic structure to a heat treatment in an oxidizing gas environment, such as air or air enriched by oxygen. The heat treatment may e.g. be performed at a temperature of at least about 250° C., such as from about 300° C. to about 600° C., such as from about 400° C. to about 500° C.

The lower the temperature the less is the risk of formation of defect on the other hand the higher the temperature the faster will the reaction take place and the more effective will the purification be.

The purification is advantageously performed prior to the wash coating.

Advantageously, the size ratio between the mean grain size of the first ceramic powder and the mean grain size of the second ceramic powder lies in the range of approximately 10:1 to 2:1, such as 6:1 to 3:1.

The mean grain size of the first ceramic powder and/or the mean grain size of the second ceramic powder advantageously has/have a narrow grain size distribution, preferably at least 90% by weight of the first ceramic powder and/or the second ceramic powder are within about 0.5 and about 2 times the mean grain size of the respective ceramic powder.

The grain size (including nanoparticle size) is determined in accordance with ISO 8486-121996-Bonded abrasives (determination and designation of grain size distribution Part I: Macrogrits F4 to F220), ISO 8486-2zl9967Bonded abrasives—(Determination and designation of grain size distribution—Part 2: Microgrits F230 to F1200) and/or, JAPANESE INDUSTRIAL STANDARD JIS R6001 (1998) (Abrasive Grain Size Distribution).

In an embodiment, the mean grain size of the first ceramic powder is from about 5 μm to about 50 μm and the mean grain size of the second ceramic powder is from about 0.5 μm to about 10 μm, such as wherein the mean grain size of the first ceramic powder is from about 10 μm to about 30 μm and the mean grain size of the second ceramic powder is from about 1 μm to about 5 μm.

The additives mainly have the purpose of providing a good adhesion between the grains of the ceramic powders and to ensure a good processability. Advantageously the additives comprise one or more of a binder, a plasticizer, a dispersant, a surfactant a lubricant or any combinations thereof.

The paste may be shaped to practically any desired shape. In principle, any method of shaping may be applied. Examples of suitable methods include casting, isostatic pressing, 3D printing, injection molding, extruding, cutting or any combinations thereof.

When the paste is shaped, the shaped structure is referred to as a “green ceramic structure”.

The shaping advantageously comprises providing the green ceramic structure to have an elongate shape, such as a cylinder shape or an angular prism shape, with one or more elongate through going channels, preferably arranged in a honeycomb structure, such as channels of polygonal, circular or elliptical shape or any combinations thereof.

Before sintering, the method preferably comprises burning off the additive. The additives will burn off at a much lower temperature than the sintering temperature. It is desired to allow the additive to fully burn off before heating to the sintering temperature.

Methods of sintering are well known in the art. Preferably, the sintering comprises treating the green ceramic structure at a sintering temperature for a sufficient time to bind the ceramic grains to form the ceramic body portion.

In an embodiment, the method comprising applying the skin layer as described above onto the body portion. The method preferably comprises applying a suspension of ceramic nanoparticles onto a preselected outer surface area of the body portion, drying the coated body portion and sintering the ceramic nanoparticles to form the skin layer.

The suspension of ceramic nanoparticles is applied onto the part of the body portion where it is desired to have the skin layer. When applying the suspension of ceramic nanoparticles, care should be taken that the suspension is substantially not penetrating into the body portion, but mainly remain at the outer surface. In an embodiment, the suspension of ceramic nanoparticles is at most penetrating into the body portion at a depth of 200 μm, such as at most at a depth of 100 μm, such as at most a depth of 50 μm.

To ensure that the skin layer pores obtained are relatively small, it is desired that the ceramic nanoparticles are relatively small. Preferably, the ceramic nanoparticles have a mean grain size of less than about 1 μm, such as from about 5 nm to about 800 nm, such as from about 10 nm to about 500 nm.

Advantageously, the ceramic nanoparticles have a mean grain size of less than about 25% of the mean grain size of the second ceramic powder, preferably less than about 10% of the mean grain size of the second ceramic powder.

After application of the suspension of ceramic nanoparticles, the body portion with the nanoparticles is dried and is subjected to a sintering process to sintering the ceramic nanoparticles and forming the skin layer.

The body portion with or without the skin layer may advantageously have an elongate shape comprising a first and a second end outer face and an outer face area extending between the first and the second end outer faces.

Advantageously, the preselected outer surface area of the body portion and/or a preselected outer surface area of the skin layer onto which the chemically selective membrane is applied may partly or fully comprises the outer face area extending between the first and the second end outer faces.

In an embodiment, the preselected outer surface area excludes at least a part of the first and the second end outer faces.

The elongate shape, may be a cylinder shape or an angular prism shape comprising one or more elongate through going channels and the chemically selective membrane e.g. in the form of a polymer solution may e.g. be applied onto the preselected outer surface area comprising the outer surface except the end faces of the cylinder shape or the angular prism shape.

The invention also comprises a ceramic support suitable for a catalyst.

The ceramic support comprises a body portion with a multi modal pore structure, having a modality selected from trimodal, quadrimodal and pentamodal.

The body portion of the ceramic support comprises a first mode of pores, a second mode of pores and a third mode of pores, wherein the first mode of pores having a first mean pore size MP50, which is between 2 and 100 μm, the third mode of pores having a third mean pore size up to 100 nm and the second mode of pores having a second mean pore size between the first mean pore size and the third mean pore size, preferably the first mean pore size is between 4 and 50 μm, such as between 6 and 25 μm.

The very narrow mean pore size of the third mode of pores, contributes to ensure a high specific surface area of the body portion of the ceramic support, which makes the support structures very advantageous for supporting a catalyst.

The multimodal pore size distribution of the body portion of the ceramic support may be characterized by the presence of at least three distributions (modes) of pores with respective mean pore size (MP50) sizes. The pore size distribution of the respective modes of pores may be overlapping or preferably non-overlapping.

Each mode of pores may be characterized by a single mean pore size value.

The unique pore structure of the ceramic support ensures a very high specific surface area combined with a desired relatively low flow resistance. This makes the ceramic support very beneficial for use as a catalytic support, for example to form a Supported Ionic Liquid Phase (SILP) and/or a Supported Liquid Phase (SLP) catalysts.

The ceramic support of the invention may be impregnated with any desired catalyst or catalyst system e.g. using washcoating or any other methods as known in the art.

Advantageously, the body portion of the ceramic body comprises a fourth mode of pores having pores of a fourth mean pore size smaller than the third mean pore size and optionally a fifth mode of pores having pores of a fifth mean pore size smaller than the fourth mean pore size.

In an embodiment, at least about 90% of the pore volume of the body portion are formed by pores of the first, the second and the third modes of pores having respective mean pore sizes and optionally of the fourth and the fifth modes of pores with respective mean pore sizes, preferably at least about 95%, such as 98% of the pore volume of the body portion are formed by pores of the first, the second and the third modes of pores and optionally of the fourth and the fifth modes of pores.

One or more, preferably each of the modes of pores mean has a narrow pore size distribution wherein at least 50% by volume of the pores has a pore size diameter within±5% from the mean pore size, preferably at least about 75 by volume of the pores has a pore size diameter within±5% from the mean pore size, preferably at least about 95% by volume of the pores has a pore size diameter within±5% from the mean pore size.

Preferably, the body portion has a trimodal pore structure. The second mean pore size may for example be between 100 nm and 1 μm, such as between 200 nm and 500 nm and the third mean pore size may for example be between 10 nm and 100 μm, such as between 20 nm and 50 nm.

The ceramic support may advantageously comprise one or more of the ceramic components mentioned above.

The ceramic support may comprise as described above.

The ceramic support may be as described above. For example, it may comprise a chemically selective membrane and/or it may be a monolithic ceramic support or a pellet.

The ceramic support advantageously comprise at least one channel, such as at least one, preferably a plurality of channels of polygonal, circular or elliptical shape.

In an embodiment, the ceramic support has an elongate shape comprising a first and a second end faces and wherein the at least one channel is a through going channel, preferably passing through the first and the second end faces

In an embodiment, wherein the ceramic support has a cylinder shape or an angular prism shape, with one or more elongate through going channels, preferably arranged in a honeycomb structure, such as channels of polygonal, circular or elliptical shape or any combinations thereof.

Advantageously, the ceramic support is obtainable by the method as described herein.

All features of the inventions including ranges and preferred ranges can be combined in various ways within the scope of the invention, unless there are specific reasons not to combine such features.

### BRIEF DESCRIPTION OF THE EXAMPLES AND DRAWING

The invention is illustrated further below in connection with selected examples and embodiments and with reference to the figures. The figures are schematic and may not be drawn to scale.

FIG. 1 (left) shows the morphology of an embodiment of the body portion of the support structure of the invention.

FIG. 1 (right) shows a skin layer of an embodiment of the support structure of the invention.

FIG. 2 shows meso-pore size distribution as a function of oxide/hydroxide nanoparticles of the washcoating,

FIG. 3 shows pore size distributions of embodiments of the ceramic support of the invention.

FIG. 4 shows pore size distribution of the SiCf and SiCc of example 1 and 2.

FIGS. 5a and 5b show pore size distributions of embodiments of the ceramic support of the invention according to example 5.

FIG. 6 shows is a cross sectional and magnified view of an embodiment of the ceramic support of the invention.

FIG. 7 shows a number of embodiments of support structures of the invention.

### Example 1

A number of monolithic porous ceramic structures were produced using the method described in U.S. Pat. No. 7,699,903. For each porous ceramic structure, a paste of a-SIC powder with well-defined particle size distribution was produced and shaped into a multi-channel monolith, dried, and sintered at an appropriate temperature. The monolith structures were shaped to have a cylindrical form with a length of 200 and a diameter of 25.4 mm. Each monolithic structure contained 30 elongate through going channels extending in the length of the monolithic structure. Each channel was 3 mm in diameter.

To obtain monoliths with a finer or coarser core, namely SiCf and SiCc, two different first ceramic powders with respective first mean particle sizes were used: 17.3 μm (fine) and 36.5 μm (coarse). Each of these first ceramic powders were mixed with a second ceramic powder with a second mean particle size about 0.1 times the respective first mean particle size.

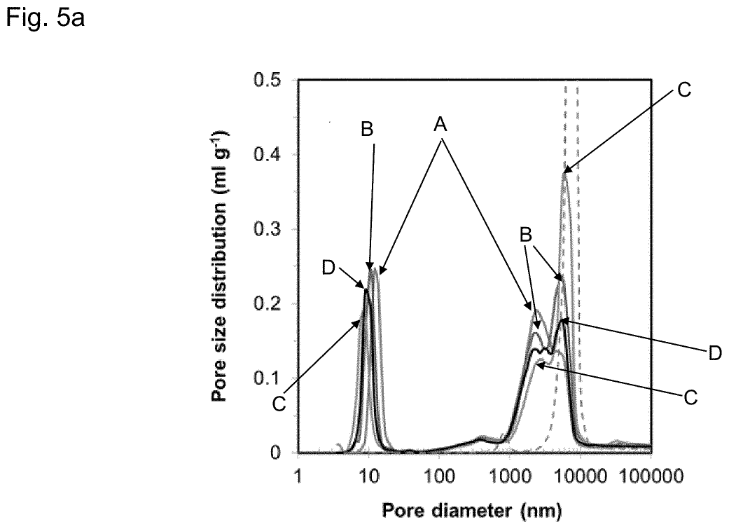

The monolithic porous ceramic structures had a monomodal macropore structure, half of the monolithic porous ceramic structures had a coarser mean pore size of 14.9 μm (referred to as SICc) and the other half had a finer mean pore size of 7.5 μm (referred to as SICf). The pore size distribution of the SiCf and SiCc are shown in FIG. 4.

### Example 2

A skin layer was applied to the monolithic porous ceramic structures. A suspension of sub-μ sized α-SiC particles was prepared and applied onto the outer surface, leaving the channels free of the suspension. The suspension was dried and sintered, to form a SiC skin. The skin had a mean pore size of 848 nm and a thickness of 45-60 μm.

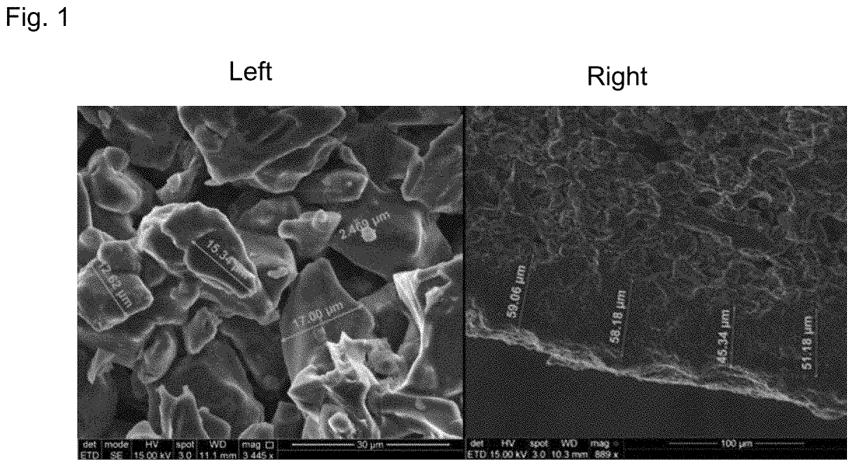

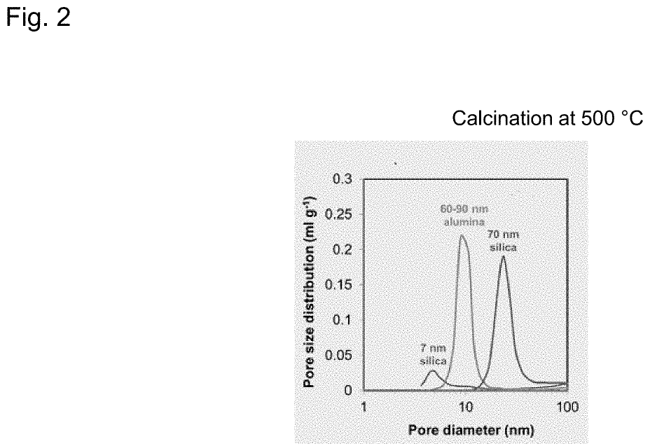

The skin layer resulted in that the external surface roughness was reduced without altering the composition of the body portion of the support. FIG. 1 (left) shows the morphology of the body portion of the SiC monolithic structure, with large macrovoids (pores) between SiC particles of smooth surface. FIG. 1 (right) focuses on the defect-free SiC skin.

### Example 3

The monolithic porous ceramic structures of example 2 were infiltrated with metal oxide particles by submerging the structures into a colloidal silica suspension with particle sizes of 7 nm. The infiltration was performed by immersing (washcoating) the monolithic porous ceramic structures into the respective colloidal suspensions. After immersing, excess suspension was removed.

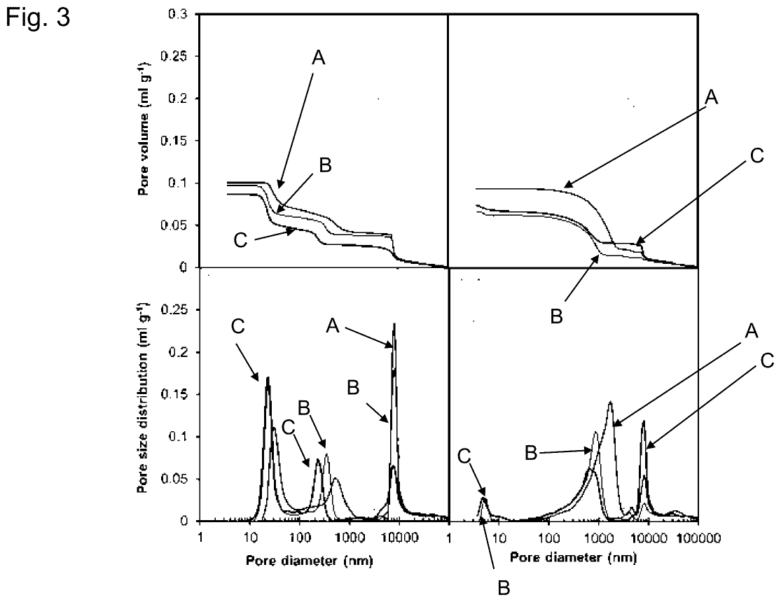

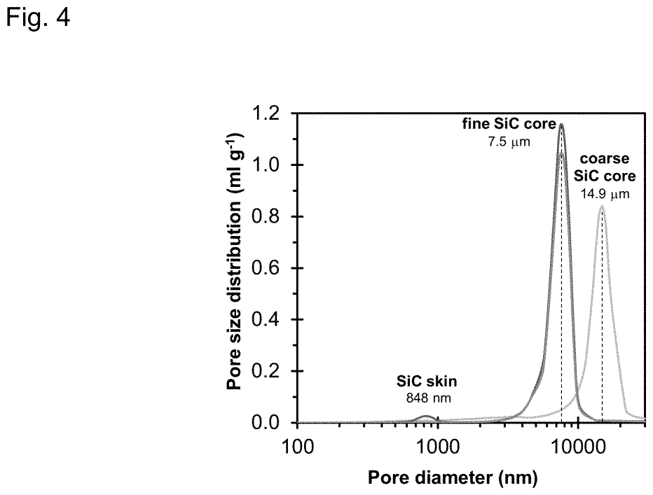

For some of the monolithic porous ceramic structures the washcoating was repeated. After four layers of washcoat, followed by calcination, 17% of the monolith mass consisted of silica and the prevalent pore size was below 1.5 μm as shown in FIGS. 2 and 3. FIG. 3 also demonstrates how calcination temperature can is used to tune pore size distribution.

| # | calcination temperature | |
|---|---|---|
| A (red) | 900° | C. |
| B (blue) | 700° | C. |
| D (Black) | 500° | C. |

### Example 4

The monolithic porous ceramic structures of example 2 were infiltrated following the method of example 3 by submerging the structures into a colloidal silica suspension with particle sizes of 70 nm.

After two layers of washcoat, followed by calcination, 20% of the monolith mass consisted of silica and the prevalent pore size was below 0.1 μm as shown in FIGS. 2 and 3. FIG. 3 also demonstrates how calcination temperature can is used to tune pore size distribution.

| # | calcination temperature | |
|---|---|---|
| A (red) | 900° | C. |
| B (blue) | 700° | C. |
| D (Black) | 500° | C. |

### Example 5

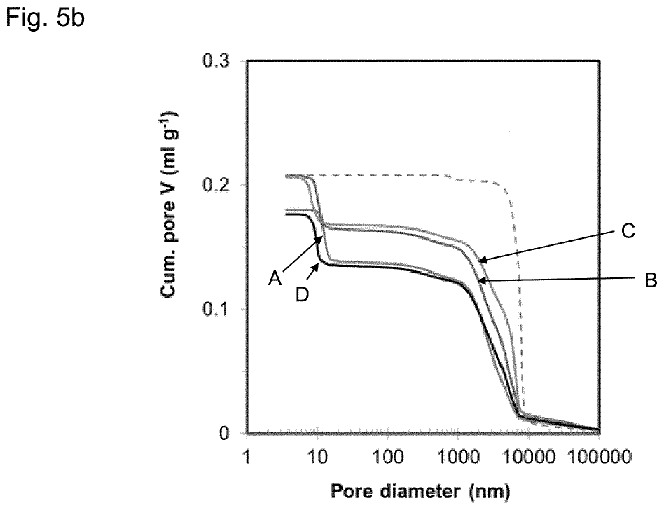

The monolithic porous ceramic structures of example 2 were infiltrated with metal oxide particles following example 3 using a colloidal alumina suspension with particle sizes of 60-90 nm. After four layers of washcoat, followed by calcination, 14% of the monolith mass consisted of silica and new population of 10 nm pores was formed while the main prevalent pore size was between 1 and 10 μm as shown in FIGS. 2, 5a and 5b. FIGS. 5a and 5b also demonstrates how calcination temperature can is used to tune pore size distribution. The calcination temperatures were as follows:

| # | calcination temperature | |
|---|---|---|
| A (red) | 900° | C. |
| B (blue) | 700° | C. |
| C (green) | 600° | C. |
| D (Black) | 500° | C. |

The dotted line indicates the macropore structure prior to washcoating with oxide/hydroxide nanoparticles.

The ceramic supports obtained in examples 3-5 were further analyzed.

It was found that the washcoating and calcinating with metal oxides or metal hydroxides resulted in that a plurality of the macropores of the body portion was partially filled and the porous distribution, which is obtained, is different from the original. The inter-particle voids of the SiC body were filled with metal oxide nanoparticles, which lead to the formation of two populations of smaller pores. Thus, the monoliths infiltrated by this procedure present a trimodal pore size distribution, with a portion of big macropores, a portion of small macropores, and a portion of mesopores. The formation process of the smaller macropores may be explained by the adhesion of the metal oxide on the walls of macropores. At higher calcination temperatures these pores increase in volume and diameter as the nanoparticles melts to a larger extend.

The accumulated pore volumes and pore size distributions obtained at maximum silica loads are depicted in FIG. 3 and contain the pore volume fraction for each kind of pore. The voids generated with the small (7 nm) and the big (70 nm) nanoparticles are around 5 and 24 nm in diameter, respectively.

The specific surface area was determined by MIP. The non-infiltrated monolith (SiCf) has a specific surface area of 0.1 m² g⁻¹. The infiltrated samples calcined at moderate temperatures present significantly higher values, as the specific surface area essentially is closely linked to the size and volume of the micro- and mesopores.

The specific surface area obtained may depend on the colloidal solution employed for the washcoat as well as the calcination temperature. The highest specific surface area was obtained for the samples infiltrated with alumina four times and smallest particles (7 nm). It is believed that this is caused by the higher volume of relatively smaller mesopores.

The washcoating and calcinating with metal oxides or metal hydroxides showed that a plurality of the macropores of the body portion, are filled and a new porous distribution is obtained. The inter-particle voids among the SiC macroporous are filled with metal oxide nanoparticles, which lead to the formation of two populations of smaller pores. Thus, the monoliths infiltrated by this procedure present a trimodal pore size distribution, with some remaining large macropores, some newly formed smaller macropores, and some mesopores not previously present. The origin of the smaller macropores can be assigned to the agglomeration of the metal oxide on. The size and volume of these small pores grow with the calcination temperature due to the increased viscosity of the oxides at higher temperature.

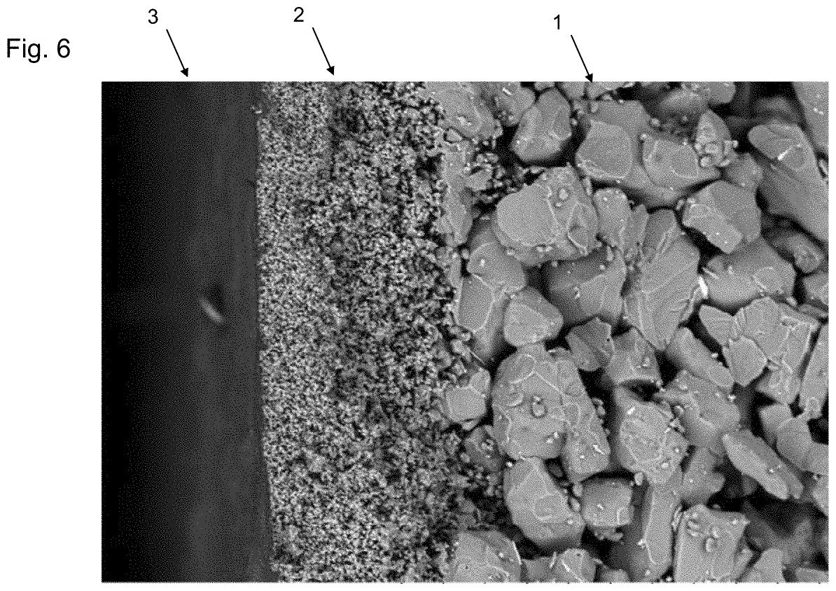

FIG. 6 shows an outer wall section of an embodiment of a support structure of the invention. It can be seen that the body portion 1, is coated with a skin layer 2, which again is coated with a selective membrane 3.

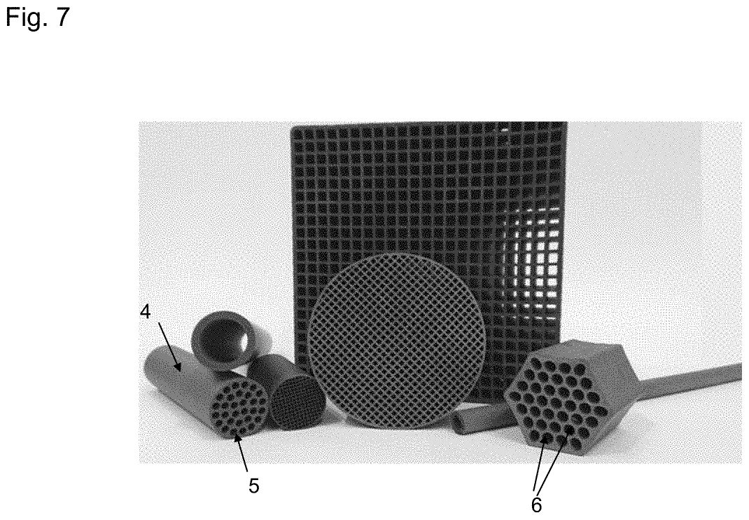

FIG. 7 shows a number of embodiments of support structures of the invention. As illustrated the support structure may have channels 6 e.g. of polygonal, circular or elliptical shape. The ceramic support preferably has a cylinder shape or an angular prism shape, e.g. square or hexagonal as illustrated. A number of elongate through going channels passing through the first and said second end faces 5. An outer surface 4 may be covered by a selective membrane.

1. A method of producing a ceramic support suitable for a catalyst, the method comprising
providing a porous ceramic structure, comprising a body portion with a monomodal macropore structure, wherein the macropores comprises a first mean pore size;
washcoating the porous ceramic structure using a suspension comprising oxide and/or hydroxide nanoparticles;
drying and calcinating the washcoated porous ceramic structure at a temperature below the melting point of the nanoparticles.

2. The method of claim 1, wherein macropores with the first mean pore size has a narrow pore size distribution wherein at least 50% by volume of the macropores has a pore size diameter within±5% from the mean pore size, preferably at least about 75% by volume of the macropores has a pore size diameter within±5% from the mean pore size, preferably at least about 95% by volume of the macropores has a pore size diameter within±5% from the mean pore size.

3. The method of claim 1 or claim 2, wherein first mean pore size is between 2 and 100 μm, such as between 4 and 50 μm, such as between 6 and 25 μm.

4. The method of any one of the preceding claims, wherein the porous ceramic structure comprises a skin layer comprising a skin layer mean pore size, preferably the skin layer mean pore size is up to about 25% of the first mean pore size, such as up to about 15% of the first mean pore size.

5. The method of claim 4, wherein the pores of the skin layer has a narrow pore size distribution wherein at least 50% by volume of the skin layer pores has a pore size diameter within±5% from the skin layer mean pore size, preferably at least about 75% by volume of the skin layer has a pore size diameter within±5% from the skin layer mean pore size, preferably at least about 95% by volume of the skin layer pores has a pore size diameter within±5% from the skin layer mean pore size.

6. The method of claim 4 or claim 5, wherein skin layer mean pore size is between 100 nm and 3 μm, such as between 400 nm and 2 μm, such as between 600 nm and 1 μm.

7. The method of any one of claims 4-6, wherein the body portion comprises one or more ceramic components forming the macropores, and wherein said skin layer comprises at least one of said one or more ceramic components.

8. The method of any one of claims 4-7, wherein the body portion comprises one or more ceramic components forming the macropores, and wherein said skin layer comprises at least one other ceramic component than the body portion.

9. The method of any one of claims 4-8, wherein the skin layer forms an outer surface layer of the porous ceramic structure and is at least partly covering the body portion.

10. The method of any one of the preceding claims, wherein the porous ceramic structure comprises one or more crystalline ceramic components, such as alumina, zirconia, titania, boride, nitride, silicon carbide, mullite or any combinations comprising one or more of these.

11. The method of any one of the preceding claims, wherein the porous ceramic structure comprises one single ceramic component.

12. The method of any one of the preceding claims, wherein the porous ceramic structure comprises silicon carbide.

13. The method of any one of the preceding claims, wherein the nanoparticles are selected from metal oxides or metal hydroxides, such as but not limited to, scandium, yttrium, titanium, zirconium, aluminum, gallium, indium, silicon, germanium, antimony, lanthanum, cerium, samarium, hafnium oxide and/or hydroxide or any combinations comprising one or more thereof.

14. The method of any one of the preceding claims, wherein the nanoparticles have a D50 grain size of from about 0.1-200 nm, such as from about 1-150 nm.

15. The method of any one of the preceding claims, wherein the nanoparticles are selected to have grain size distribution wherein at least 50% by number of the nanoparticles have a particle size within±5% from the mean particle size, preferably at least about 75% by number of the nanoparticles have a particle size within±5% from the mean particle size, preferably at least about 95% by number of the nanoparticles have a particle size within±5% from the mean particle size.

16. The method of any one of the preceding claims, wherein the nanoparticles have a grain size distribution comprising that at least 90% by weight of the grains is within 0.5 times to 2 times the D50 grain size.

17. The method of any one of the preceding claims, wherein the washcoating is repeated, preferably until saturation is reached.

18. The method of any one of the preceding claims, wherein the suspension of nanoparticles is an aqueous or organic suspension of from about 1% by weight to about 70% by weight of the nanoparticles.

19. The method of any one of the preceding claims, wherein the porous ceramic structure is of composite material, preferably comprising two or more different ceramic components.

20. The method of any one of the preceding claims, wherein an outer surface part of porous ceramic structure is coated, preferably with a selective membrane.

21. The method of claim 20, wherein the porous ceramic structure comprises said skin layer and wherein said selective membrane is coated onto at least a part of said skin layer.

22. The method of any one of the preceding claims, wherein the porous ceramic structure is a monolithic structure.

23. The method of any one of the preceding claims, wherein the porous ceramic structure is a pellet.

24. The method of any one of the preceding claims, wherein the porous ceramic structure comprises at least one channel, such as at least one, preferably a plurality of channels of polygonal, circular or elliptical shape.

25. The method of any one of the preceding claims, wherein the method comprises producing the body portion of the porous ceramic structure, the method comprising
selecting a first ceramic powder with a first mean grain size,
selecting a second ceramic powder with a second mean grain size that is substantially smaller than the first mean grain size,
mixing of the first and second ceramic powders with one or more additive to form a paste,
shaping the paste to a green ceramic structure, and
sintering the green ceramic structure at a temperature sufficiently high to at least partly sintering the ceramic grains.

26. The method of claim 25, wherein the sintering of the green ceramic structure is performed in inert environment, such as in a vacuum atmosphere or in an inert gas atmosphere.

27. The method of any one of the preceding claims, wherein at least the body portion of the porous ceramic structure is subjected to heat treatment in an oxidizing gas environment.

28. The method of claim 27, wherein the heat treatment is performed at a temperature sufficiently high to oxidize at least a part of fee carbon located in the body portion.

29. The method of any one of claims 25-38, wherein the size ratio between the mean grain size of the first ceramic powder and the mean grain size of the second ceramic powder lies in the range of approximately 10:1 to 2:1, such as 6:1 to 3:1.

30. The method of any one of claims 25-29, wherein the mean grain size of the first ceramic powder and/or the mean grain size of the second ceramic powder has a narrow grain size distribution, preferably at least 90% by weight of the first ceramic powder and/or the second ceramic powder are within about 0.5 and about 2 times the mean grain size of the respective ceramic powder.

31. The method of any one of claims 25-30, wherein the mean grain size of the first ceramic powder is from about 5 μm to about 50 μm and the mean grain size of the second ceramic powder is from about 0.5 μm to about 10 μm, such as wherein the mean grain size of the first ceramic powder is from about 10 μm to about 30 μm and the mean grain size of the second ceramic powder is from about 1 μm to about 5 μm.

32. The method of any one of claims 25-31, wherein the additive comprises one or more of a binder, a plasticizer, a dispersant, a surfactant a lubricant or any combinations thereof.

33. The method of any one of claims 25-32, wherein the method comprises burning off the additive prior to sintering.

34. The method of any one of claims 25-33, wherein the shaping comprises casting, isostatic pressing, 3D-printing, injection molding, extruding, cutting or any combinations thereof.

35. The method of any one of claims 25-34, wherein the shaping comprises providing the green ceramic structure to have an elongate shape, such as a cylinder shape or an angular prism shape, with one or more elongate through going channels, preferably arranged in a honeycomb structure, such as channels of polygonal, circular or elliptical shape or any combinations thereof.

36. The method of any one of claims 25-35, wherein the sintering comprises treating the green ceramic structure at a sintering temperature for a sufficient time to bind the ceramic grains to form the ceramic body portion.

37. The method of any one of claims 25-36, wherein the method comprising applying the skin layer onto the body portion, the method comprises applying a suspension of ceramic nanoparticles onto a preselected outer surface area of the body portion, drying the coated body portion and sintering the ceramic nanoparticles to form the skin layer.

38. The method of claim 37, wherein the ceramic nanoparticles have a mean grain size of less than about 1 μm, such as from about 5 nm to about 800 nm, such as from about 10 nm to about 500 nm.

39. The method of claim 37 or claim 38, wherein the ceramic nanoparticles have a mean grain size of less than about 25% of the mean grain size of the second ceramic powder, preferably less than about 10% of the mean grain size of the second ceramic powder.

40. A ceramic support suitable for a catalyst, the ceramic support comprises a body portion with a multi modal pore structure, having a modality selected from trimodal, quadrimodal and pentamodal, and wherein the body portion of the ceramic body comprises a first mode of pores, a second mode of pores and a third mode of pores, wherein the first mode of pores having a first mean pore size MP50, which is between 2 and 100 μm, the third mode of pores having a third mean pore size up to 100 nm and the second mode of pores having a second mean pore size between the first mean pore size and the third mean pore size, preferably the first mean pore size is between 4 and 50 μm, such as between 6 and 25 μm.

41. The ceramic support of claim 40, wherein the body portion of the ceramic body comprises pores of a second mean pore size smaller than the first mean pore size, pores of a third mean pore size smaller than the second mean pore size and optionally pores of a fourth mode of pores having pores of a fourth mean pore size smaller than the third mean pore size and optionally a fifth mode of pores having pores of a fifth mean pore size smaller than the fourth mean pore size.

42. The ceramic support of claim 40 or claim 41, wherein at least about 90% of the pore volume of the body portion are formed by pores of the first, the second and the third mean pore size and optionally of the fourth and the fifth mean pore size, preferably at least about 95%, such as 98% of the pore volume of the body portion are formed by pores of the first, the second and the third mean pore size and optionally of the fourth and the fifth mean pore size.

43. The ceramic support of any one of claims 40-42, wherein one or more, preferably each, of the modes of pores has a narrow pore size distribution wherein at least 50% by volume of the pores has a pore size diameter within±5% from the mean pore size, preferably at least about 75 by volume of the pores has a pore size diameter within±5% from the mean pore size, preferably at least about 95% by volume of the pores has a pore size diameter within±5% from the mean pore size.

44. The ceramic support of any one of claims 40-43, wherein the body portion has a trimodal pore structure.

45. The ceramic support of any one of claims 40-44, wherein the second mean pore size, is between 100 nm and 1 μm, such as between 200 nm and 500 nm.

46. The ceramic support of any one of claims 40-45, wherein the third mean pore size, is between 10 nm and 100 μm, such as between 20 nm and 50 nm.

47. The ceramic support of any one of claims 40-46, wherein the ceramic support comprises one or more crystalline ceramic components, such as alumina, zirconia, titania, boride, nitride, silicon carbide, mullite or any combinations comprising one or more of these.

48. The ceramic support of any one of claims 40-47, wherein the ceramic support comprises one single ceramic component, preferable the porous ceramic structure comprises silicon carbide.

49. The ceramic support of any one of claims 40-48, wherein the ceramic support comprises a chemically selective membrane, the chemically selective membrane is preferably formed as a polymeric coating of at least a part the outer surface area of the body portion.

50. The ceramic support of any one of claims 40-49, wherein the ceramic support is a monolithic ceramic support.

51. The ceramic support of any one of claims 40-49, wherein the ceramic support is a pellet.

52. The ceramic support of any one of claims 40-51, wherein the ceramic support comprises at least one channel, such as at least one, preferably a plurality of channels of polygonal, circular or elliptical shape.

53. The ceramic support of claim 52, wherein the ceramic support has an elongate shape comprising a first and a second end faces and wherein the at least one channel is a through going channel, preferably passing through said first and said second end faces.

54. The ceramic support of claim 52 or claim 53, wherein, wherein the ceramic support has a cylinder shape or an angular prism shape, with one or more elongate through going channels, preferably arranged in a honeycomb structure, such as channels of polygonal, circular or elliptical shape or any combinations thereof.

55. The ceramic support of any one of claims 40-54, wherein the ceramic support is obtainable by the method as claimed in any one of claims 1-36.
